(19) United States
(12) Patent Application Publication
(10) Pub. No.: US 2008/0320102 A1
(43) Pub. Date: Dec. 25, 2008

(54) INFORMATION RETRIEVAL SYSTEM

(76) Inventors: Atle Rordam, Oslo (NO); Vegard Andu Robertren Figeurchou, Orlo (NO)

Correspondence Address: BIRCH STEWART KOLASCH & BIRCH, PO BOX 747, FALLS CHURCH, VA, 22040-0747, US

(21) Appl. No.: 12/143,575

(22) Filed: Jun. 20, 2008

(30) Foreign Application Priority Data
Jun. 22, 2007 (NO) 2007 3206

(51) Int. Cl. G06F 15/16

(52) U.S. Cl. 709/218

(57) ABSTRACT

Method for extracting information from a first web based information network including at least one computer, the network containing user specific information, comprising the steps of accessing a user specific web page containing the user information, detecting specific user dependent information, and storing the information in a number of categories, each category indicating a predetermined user specific information.

### FIELD OF INVENTION

The invention relates to online social communities servers, users agents and especially moving User Generated Content on behalf of the user and owner of the content based on the ownership of the content, the one that created and uploaded the content may move and use it.

### BACKGROUND OF THE INVENTION

In our daily lives a lot of us are members of online social communities. Today estimated around as many as several hundred of millions of people are in some way, the user of a online social communities service also mentioned as social network services.

Some are even member of several such services.

A fast growing number for people are joining in on new online social communities or social networks services, known to hold only one asset, User Generated Content (UGC).

These great masses will eventually start to move and wish to get their profile data mobile, in such way as copy and paste from one site to another is unnecessary.

In the more and more likely event that the content policy changes in one community to affect the user generated content, the user may wish to preserve his/her content by way of moving it to another community where the policy allows for the user to store his/her generated content.

In at least one major online social community or social network service, there is clausules to be found in <<user terms>>, indicating that the users have given up their rights more or less to the owner of the service.

There are cases of clear misuse as content defined as UGC as for commercial operations as advertising, whereas ones picture can all of a sudden appear on super boards etc without the owners of the UGC's approval or economical benefits.

Lets say that a major online social communities service, also named as social networks services, sells out all shares to the advertising industry. According to the User terms found on at least one such site/service, the user have no rights in such case, according to <<user terms>>.

The protection of human rights such as stated in the Universal Declaration of Human Rights, Adopted and proclaimed by General Assembly resolution 217 A (III) of 10 Dec. 1948, whereas at least article 27, second section states:

“Everyone has the right to the protection of the moral and material interests resulting from any scientific, literary or artistic production of which he is the author.”

This indicates clearly that UGC as described in http://en.wikipedia.org/wiki/User-generated_content fits into this UN protected Human Right.

A uncompleted list showing what a Online social Community is to be found at Wikipedia here: http://en.wikipedia.org/wiki/List_of_social_networking_websites

and the definition of such service is to be found here:

http://en.wikipedia.orgiwiki/Social_network service

Since the actual physical server, may even change country as where they actually host the servers, a user owning UGC on such a site can never know what tomorrow, brings and who is the current self claimed owner of their UGC, as at least one such service today claims to be as well as the original owner who posted UGC in the first place.

For this reason there is a high risk of misuse of UGC and it is very likely to become a variety of needs to obtain a control, use the right to move, use, preserve and present their content, data, limited to what described as user generated content: http://en.wikipedia.org/wiki/User-generated_content

But not limited to only move UGC, but also to delete content. Deleting content is a right not always granted; due to the fact that many networks are simply closing the users out from certain domains hosting online social communities or social network services.

An example of such sudden change in the owner of UGC's, urge to delete parts of, delete all content and/or even the account its self.

Such worries are for real, in an Saudi-Arabian man or womans life, since they might be on one or more major online social network or social network service, and if one or more of those company(s)/server(s) physically moves from USA, to Saudi-Arabia. the content and responsibility will change a lot and criminal prosecution and even jail sentence without a real trial, is a real threat.

Also there are several well known issues regarding security and systems with a Universal Identity in such services as OpenID, whereas the revealing the name in it self is a weakness. The OPEN id.

In this case you must trust a larger network, a unknown constellation. with access to all of your online social network or online network services. Also the simplification of using such an easy user credentials system, will also provide a third or a forth part, more ease of gaining control of your identities.

Today the online social network or online network services are in some cases collaborating, using a third part server, to create more easy of creating a new profile creating it by transferring by using cross references and other technologies that are approaching towards giving the users of online social network or online network services an easy way of adding their identity to more than one online social community.

There are many organizations where as more information, regarding online social network or online network services and security/privacy and even human rights issues can be found:

www.eff.org and www.privacy.org

In general, any user of one or more social network or online network services, with a minimum responsibility and integrity, would at as far as possible, avoid getting their user credentials stored in more places, computers or servers, than whats needed, as spreading your user credentials around, is a security problem in it self.

As the largest social network or online network services, today are being watched very closely for being possibly a national security issue, such as suggested by officials (NSM) in Norway and Israel Military, its important to remember that any step toward more secure handling of user credentials and systems concerning this issue and UGC, is at the out most importance.

### SUMMARY OF THE INVENTION

Method for secure transport of user generated content from one online social network to another on behalf of the owner of the user generated content for such purposes as a backup and/or a controlled process for generating a new profile from within a secondary online social network, based on the data from a another online social network as a peer to peer transmission without a third server in between.

Our invention uses a very user friendly way, without need to use tokens, keys or any other elements than the current user credentials, ie. user name or email address and password.

By using only this data from the user, the owner of the user generated content will actually log on to their profile, and then the site in it self, collects the user generated content, but the login is done either by the users agent with a file executed locally or directly from the server the user is logged into and wants a backup or a set of data to create the a new profile, based upon user generated content made earlier at the second online social community on the online social community the users i currently logged into.

The benefits of this is that the user gets a very simple and secure transfer by avoiding a third party or <<in between>> server and also the ease of use by only at a minimum asking for the user credentials.

Secondary there may be made some choices as the user may discriminate data not to be included in the peer to peer transport of user generated content and also choices as deleting the account or deleting user generated content from primary online social community on the secondary online social community.

There can also be choices for the user to take copy of what was on the page at the moment of executing the transfer as described above. Our service can offer and include a “whole profile” saved and encrypted with a key that is only possible to open by us, as a part of generating a guarantee of non tampered content from the user.

This way you can not only take a UGC peer to peer transmission, but also provide at any time a “time frozen” copy of all content including the interface of UGC, for later use in case of your legal rights are abused.

The invention may also has a way of removing all information collected that was not UGC, as there might be third part software, also known as mini-programs. called widgets or applications, involved or present at a profile in online social communities or social network services as the user must verify the ownership of the content after the transfer as a part of the procedure. This to avoid any misunderstandings of our perspectives and special care of separating UGC from general site content owned by a online social network or online network service or third party represented in a profile on a online social network or online network service.

A choice of whether to store the login credentials or not to store them for later use could be a choice in the graphical user interface, as one might want to repeat parts of the sequence later, or if that choice is not made, the server will not store, but delete the user credentials.

The method of the invention avoids the use of a third party server, as the transfer of data is performed as a peer to peer operation.

The invention may use https protocol as default, and secondary http protocol, if default does not respond.

The objects of the invention are thus obtained as set out in the independent claims.

The invention will be described below with reference to the accompanying drawings, illustrating the invention by way of examples.

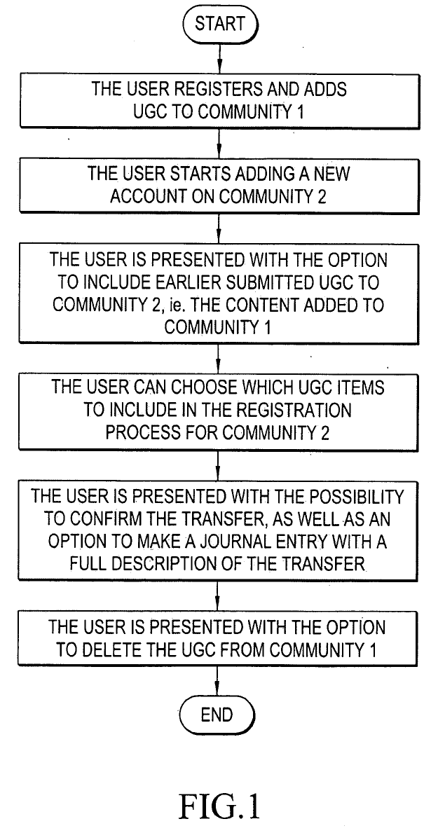

FIG. 1 illustrates the preferred method according to the invention

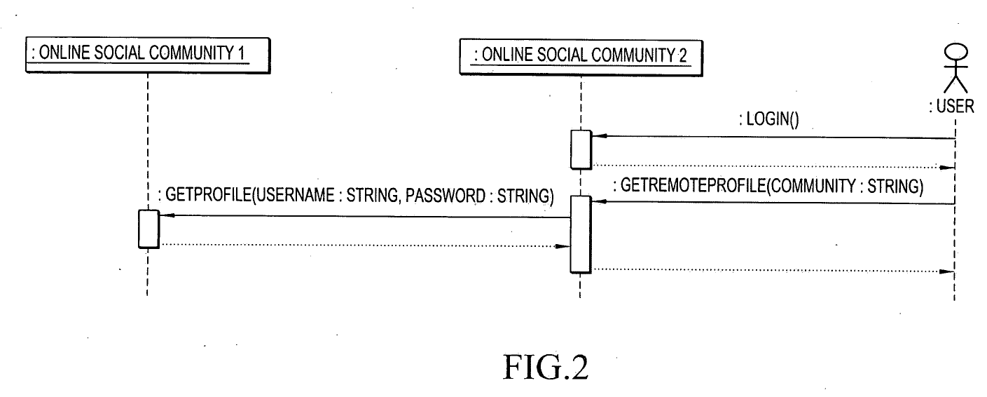

FIG. 2 illustrates and alternative method.

### METHOD DESCRIPTION

Method 1, illustrated in FIG. 1:

Using a user agent extension to preserve data:

1) When the user submits UGC to a community, the content is stored through a user-agent extension. This user agent extension stores the UGC as it is submitted. preserving the data type, data name as well as the target URL of the submission and submission time including a full version of the request itself. This information is gathered from the execution environment as well as from the HTTP request (See: http://en.wikipedia.org/wiki/Hypertext_Transfer_Protocol or http://tools.ietf.org/html/rfc2616).

The UGC is catalogued based on the name and the URL to which it was submitted. Predefined rules may govern process of cataloging the data.

2) When a user wants to move data to another community the extension aids the transmission by presenting the catalogue and suggest which fields in the registration form on the new community is to be filled with UGC from the catalogue. The identification of similar fields between the communities may be solved by a rules dictionary, based oil predefined Regular expression rules (See http://en.wikipedia.org/wiki/Regex or http://www.opengroup.org/onlinepubs/007908799/xbd/re.html for details).

When a rule matches as being identical or similar, the catalog will present appropriate UGC to insert into the registration form field.

3) Upon completion of the registration form the user may confirm or discard the choice of UGC. The user may also be presented with an option to store an encrypted and signed version of the submitted data, for future references.

4) The user may choose to delete the UGC from the first community. In this process the user-agent extension may may aid the user in finding an appropriate web page on the first community to do so. Or the user-agent extension may do so directly by executing predefined HTTP requests for deleting content on the relevant community.

### Method Summary.

The method describes a way in which the user may store UGC locally for later reuse in a pre-structured fashion. An advantage of this method is that the second community does not have to know that this UGC was meant for another community. A disadvantage is that the user has to store the UGC locally, to be able to reuse it in another community registration process.

### Method 2 Illustrated in FIG. 2:

The community request another community for UGC on behalf of the user.

1) A user completes a registration process and uploads UGC on a community (community1).

a) The community stores the UGC as it was added, by storing the HTTP request itself to a file or database.

) The user wants to register on a new community (community2): In the registration process the new community (community2) suggest that the user may import UGC from another community (this may be community1).

) The user chooses to import UGC from the previous community (community1).

4) The new community (community2) asks the user for login credentials for authenticating the user against the first community (community1). The new community (community2) also ask the user if the credentials are to be stored for future transactions or if they should to be deleted upon completion or cancellation of the transaction.

5) The user inputs the appropriate login credentials.

6) The new community (community2) performs an authenticated request for UGC targeted at first community (community1)

7) The first community (community1) responds by giving a list of available UGC.

8) The new community (community2) presents the user with a list of UGC from the first community (community1) as well as a suggestion as to which field the UGC is to be stored in.

9) The user may confirm the list as suggested or change it.

10) The user confirms the choice

11) The new community (community2) performs a new authenticated request for each individual part of UGC that the user has selected to import from the first community (community1) and stores it in the fields as the user requested.

12) The new community (community2) presents the user with an option to delete the UGC from the first community (community1).

13) If the user chooses to delete any of the UGC from the first community (community1), the new community (community2) performs an appropriate delete request for each of UGC that is to be deleted on the first community (community1).

14) As a receit of the transaction, the new community (community2) produces a signed list of the UGC that was imported from the first community (community1) for the user to store locally for future references.

### Method Summary.

The method describes a way in which the user may import UGC into a new community from a previously used community. An advantage of this method is that the import can be executed in a fashion that is tailored for the specific community that the UGC is gathered from. A disadvantage is that the user has to provide the new community with information like what community the UGC is gathered from.
Note that the methods also applies to other UGC registration pages, not only to the user registration page itself.

### Implementation Example Summary

To summarize the invention relates to a method and a system for extracting information from a first web based information network including at least one computer, the network containing user specific information, comprising the steps of accessing a user specific, web page containing the user information, detecting specific user dependent information, and storing the information in a number of categories, each category indicating a predetermined user specific information. This preferably involves transferring of user generated content from within the first network to a second network.

When the web page is secure by passwords etc the method also incorporates transmitting user specific login information to the network thus the accessing of the web page involves transmitting user credentials as user name and password or email address and password

When extracting the information the method includes the steps of accessing web page in a second information network comprising user specific information, and wherein the storing of information is performed in said second information network or in the user personal computer thus providing a backup of the information stored at the first network. The information on the first network may then automatically be deleted if the user wants to delete his account or retreat from the forum and make the information unavailable to the public.

When storing the information it may be protected by encryption and then stored as a signed file that mirrors the original content and its graphical presentation of the profile and user generated content. This may include all or parts of the extracted information.

The system according to the invention for extracting information from a computer or computer network constituting a network containing user specific information, comprises a second computer or computer network comprising a storage means for storing user specific information in a number of chosen categories. The system also comprising communication means for communicating with the first computer network and for accessing a storage in said first network, the storage representing user information related to a chosen user, the system comprising means for categorizing the user information and for storing chosen information on the second computer.

As mentioned above the second computer may be constituted by a second computer network, the storage in which representing a second web page and containing categorized user specific information, or may be a personal computer e.g. for backup purposes.

The system also involves a secondary graphical user interface in case of user generated content and profile data is located in users data before sequence is executed. The secondary user interface is limited to import data to fields in new profile without entering data into already occupied fields, such as data of birth or users profile photo.

For performing the invention the system also incorporate graphic user interfaces for receiving information from the user and reporting to the user. The graphical user interface is presented in standard file structures according standards supported in the user agent such as html and equal, e.g. for receiving user name, email address and passwords. It may also allow the user to choose or provide the address or name of the destination server, that holds your user generated content and to enter a choice to save user credentials, or at least one graphical item is usable to enter a choice of saving a full copy of the target account on a first web based information network, or a graphical item is usable to enter a choice of encrypting a full copy of the target server data presented in the user profile from the target server.

Other graphical items for allowing the user to choose the function of the system may also be to enter a choice of requesting deleting of user generated content on the server the content is imported from or to enter a choice of requesting termination or disabling the users account on target server.

The method according to the invention may be performed in functional means in a hardware system or be implemented in computer software, or a mixture of these. The computer program being executable in a web browser or on a web server and may include the steps of importing the user generated content, deleting the content and then terminating the account, as well as to show a set of imported user generated content to reproduce a profile.

1. Method for extracting information from a first web based information network including at least one computer, the network containing user specific information, comprising the steps of accessing a user specific web page containing the user information, detecting specific user dependent information, and storing the information in a number of categories, each category indicating a predetermined user specific information.

2. Method for according to claim 1, including transferring of user generated content from within the first network to a second network.

3. Method according to claim 1, wherein the accessing of the web page involves transmitting user specific login information to the network.

4. Method according to claim 1, wherein the accessing of the web page involves transmitting user credentials as user name and password or email address and password

5. Method according to claim 1, comprising the steps of accessing web page in a second information network comprising user specific information, and wherein the storing of information is performed in said second information network.

6. Method according to claim 1, wherein said storage is in a user personal computer,

7. Method according to claim 1, including the step of deleting the information stored on the first information network.

8. Method according to claim 1, including the step of terminating or make publicly unavailable the account in its self

9. Method according to claim 1, including the step of encrypting and then store as a signed file that mirrors the original content and its graphical presentation of the profile and user generated content.

10. Method according to claim 1, including the step of encrypting the all data received from first web based information network

11. Method according to claim 7, including the step of signing of a encrypted file.

12. Method according to claim 1, including the step of storing a encrypted and signed file with all data received from first web based information network

13. System for extracting information from a computer or computer network constituting a network containing user specific information, the system comprising a second computer or computer network comprising a storage means for storing user specific information in a number of chosen categories, the system also comprising communication means for communicating with the first computer network and for accessing a storage in said first network, the storage representing user information related to a chosen user, the system comprising means for categorizing the user information and for storing chosen information on the second computer.

14. System according to claim 13 wherein the second computer is constituted by a second computer network, the storage in which representing a second web page and containing categorized user specific information.

15. System according to claim 13, wherein the second computer is a personal computer.

16. System according to claim 13, whereas a there is a secondary graphical user interface in case of user generated content and profile data is localized in users data before sequence is executed.

17. System according to claim 13, whereas a secondary user interface is limited to import data to fields in new profile without entering data into already occupied fields, such as data of birth or users profile photo

18. A computer program performing the method according to claim 1, wherein a sequence does follow the steps of importing the user generated content, deleting the content and then terminating the account.

19. Computer program according to claim 18, being executable in a web browser

20. Computer program according to claim 18 executable on a web server.
